(19) United States
(12) Patent Application Publication
(10) Pub. No.: US 2004/0128877 A1
(43) Pub. Date: Jul. 8, 2004

(54) Beverage container identification method, system, and device

(76) Inventor: Kelly Luedde, Houston, TX (US)

Correspondence Address: RAYMOND R. FERRERA, INTELLECTUAL PROPERTY SERVICES, 2502 LIVELY LANE, SUGAR LAND, TX, 77479, US

(21) Appl. No.: 10/338,228

(22) Filed: Jan. 8, 2003

(51) Int. Cl. G09F 3/00

(52) U.S. Cl. 40/306

(57) ABSTRACT

A beverage identification device, system and method. Example embodiments include the use of an elastomeric band displaying a unique identifying indicia allowing for application of the band to a beverage container.

### BACKGROUND

The present invention relates to application of distinguishing identifying indicia on beverage containers.

There are many types of beverage containers (for example, soda and beer cans, bottles, glasses, etc.) that, when used to serve beverages to a group of people. The individual consumers of the containers' contents would prefer to have some identifying indicia on their container to avoid confusion over which person drank from any particular container, and there have been a variety of attempts to provide for such identification (see, e.g., U.S. Pat. Nos. 2,844,893; 3,382,779; 3,750,317; 3,854,581; 4,171,864; 4,991,337; 5,358,770; 5,704,144; 5,992,892; 6,082,030; 6,412,632; all of which are incorporated herein by reference). However, none have been widely accepted. They are too cumbersome, too costly, or too complex.

There is a need, therefore, for simple, inexpensive methods, systems, and devices, for such identification.

### SUMMARY

According to one example embodiment of the invention, a system is provided for identifying a specific beverage container from a group of beverage containers to a specific individual from a group of individuals. The system comprises: means for engaging an outer surface of the container, and means for displaying, opposite the means for engaging of the elastic compressive force, a specific identifying indicia. In a more specific example, the means for engaging comprises a means for applying an elastic compressive force to the outer surface of the container (e.g., an inner surface of an elastomeric band). In a further embodiment, the means for engaging comprises a means for applying a frictional engagement of the elastic compressive force to the outer surface of the container (e.g. a rough inner surface of a band).

In at least one example, the means for displaying comprises an outer surface of elastomeric band including a means for displaying an alpha-numeric indicia. In some examples, the means for displaying comprises means for displaying a colored indicia (e.g. alpha-numeric or other symbols, imprinted on the band, or formed integrally with the surface of the band). In some examples, multi-color indicia are displayed.

In still further examples, means are provided for displaying a further indicia (e.g., an award indicia, advertising, such as a slogan, saying, logo, or other trademark or image).

In yet a further embodiment of the invention, means are provided for relating the specific beverage container with at least one other beverage container from the group of beverage containers. In some such examples, the means for relating comprises: means for displaying a first relating indicia on the beverage container, and means for displaying a second relating indicia on the at least one other beverage container. In at least one such example, the means for displaying a first relating indicia comprises a first elastomeric band and the means for displaying a second relating indicia on the at least one other beverage container comprises a second elastomeric band. In some other examples, the first relating indicia comprises a first shape of the first elastomeric band and the second relating indicia comprises a second shape of the second elastomeric band. In at least one such example, the first shape mates with the second shape.

In a further example, the first relating indicia comprises a color of the first elastomeric band and the second relating indicia comprises a color of the second elastomeric band relating the color of the first elastomeric band (e.g., the color of the second elastomeric band consist essentially of the same color, or the color of the first elastomeric band and the color of the second elastomeric band consist essentially of complementary colors, etc.).

In yet another example, the first relating indicia comprises a number on the first elastomeric band and the second relating indicia comprises the number; while, in still a further example, the first relating indicia comprises a letter on the first elastomeric band and the second relating indicia comprises the letter.

In an even further example of the invention, a method is provided for distinctly identifying multiple beverage containers. The method comprises: distributing a group of elastomeric bands, wherein each band in the group includes an identifying indicia different from other bands in the group of bands; and applying the group of bands to a group of beverage containers. In at least one more specific embodiment, the identifying indicia comprises an alpha-numeric indicia. In another embodiment, the identifying indicia comprises a color indicia; while, in still a further example, the identifying indicia comprises an alpha-numeric indicia. As in other examples, some color indicia comprise multi-color indicia.

In still a further example, of the invention, a device is provided for identification of a beverage container. The device comprises: an elastomeric band having an inner surface and an outer surface; and an identifier of the elastomeric band viewable from the outer surface, wherein the identifier of the elastomeric band is integral with the outer surface. In at least one more specific example, the identifier comprises an alpha-numeric character on the outer surface. In a further example, the identifier is printed on the outer surface; while, in still another example, the identifier is formed in the outer surface. In still further examples, the identifier comprises a symbol having a color different from the color of a background of the outer surface. Alternatively, or in addition, in some examples, the identifier comprises an identifying portion of the outer surface having a level different from a background of the outer surface. (e.g., a raised portion or a recessed portion).

In some examples, the identifier comprises a further indicia (e.g., an award indicia, advertising, a logo, a slogan, etc.)

In yet a further example of the invention, a system is provided for identification of a plurality of beverage containers. The system comprises: a group of elastomeric bands wherein each band comprises an inner surface and an outer surface; and a unique identifier of the each elastomeric band viewable from the outer surface, wherein the unique identifier is integral with the outer surface. In at least one more specific example, the identifier comprises an alpha-numeric character on the outer surface. In a further example, the identifier is printed on the outer surface; while, in yet another example, the identifier is formed in the outer surface. In some examples, the identifier comprises a symbol having a color different from the color of a background of the outer surface, and, in further examples, the identifier comprises an identifying portion of the outer surface having a level different from a background of the outer surface (e.g., a raised portion or a recessed portion). In still further examples, the identifier comprises a further indicia, as described above.

### BRIEF DESCRIPTION OF THE DRAWINGS

FIG. 1 is a perspective view of an embodiment of the invention.

FIG. 2 is a perspective view of an embodiment of the invention.

FIG. 3 is a perspective view of an embodiment of the invention.

FIG. 4 is a perspective view of an embodiment of the invention.

FIG. 5 is a perspective view of an embodiment of the invention.

FIG. 6 is a perspective view of an embodiment of the invention.

### DETAILED DESCRIPTION OF EXAMPLE EMBODIMENTS

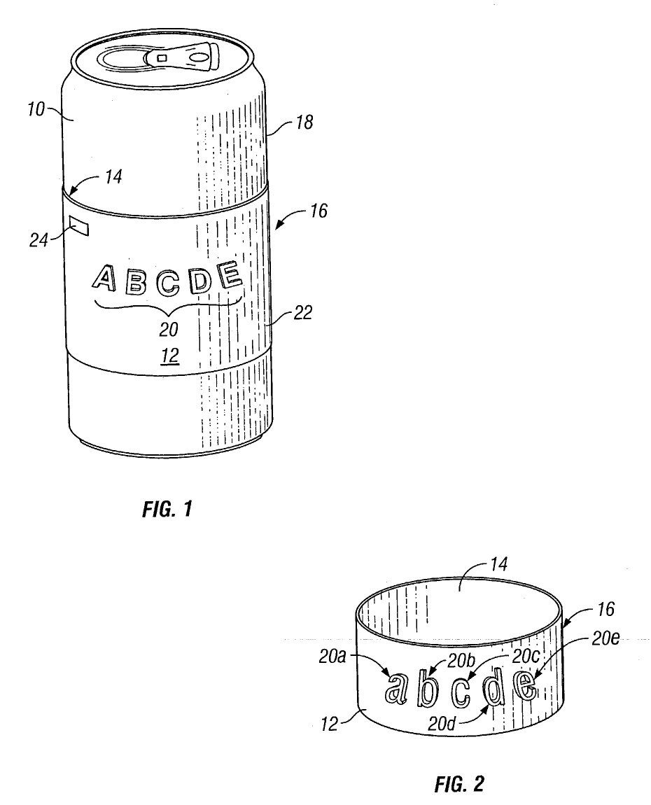

Referring now to FIG. 1, a beverage container 10, taken from a group of similar containers, comprises a drink-can (for example, for containing soda, beer, juice and other beverages that will occur to those of ordinary skill in the art). In alternative embodiments, the beverage container comprises a glass, a cup, a bottle, a beverage box, etc.) Surrounding beverage container 10 is an elastomeric band 12 (e.g., a “rubber” band) having an inner surface 14 and an outer surface 16. Inner surface 14 engages beverage container 10 by applying an elastic, compressive force to outer surface 16 of beverage container 10. In some embodiments, inner surface 14 of elastomeric band 12 makes a frictional engagement with outer surface 16 of beverage container 10.

On outer surface 16, opposite inner surface 14, is a group of alpha-numeric characters 20 that serve as a specific identifying indicia to specifically identify the beverage container 10 from other containers from the group of similar containers. The other containers in the group (not shown) are surrounded by other bands that also have specific identifying indicia; however, the specific identifying indicia on the other containers are different from the specific identifying indicia on beverage container 10. In alternative embodiments, any variety of characters, logos, or other symbols are used as identifying indicia. In still further example embodiments, the identifying indicia of band 12 comprises a color of band 12. In still further example embodiments, the identifying indicia comprises the contrast between two colors of band 12. In still further example embodiments, the identifying indicia of band 12 comprises a combination of symbols (for example, alpha-numeric characters) and colors. Further examples of identifying indicia (including, without limitation, bar-codes, data matrices, etc.) will occur to those of skill in the art.

Referring now to FIG. 2, an example embodiment is seen in which elastomeric band 12 includes raised alpha numeric characters 20a-20e. In some embodiments, raised identifying indicia 20a-20e are integrally formed in elastomeric band 12. In other examples, identifying indicia 20a-20e are applied to outer surface 16 of elastomeric band 12. In still further examples (not shown), identifying indicia are formed into outer surface 16 of elastomeric band 12 by processes know to those with skill in the art, wherein the indicia are recessed into outer surface 16. In some such examples, colors are applied to add contrast between identifying indicia and background 22 (FIG. 1) of elastomeric band 16.

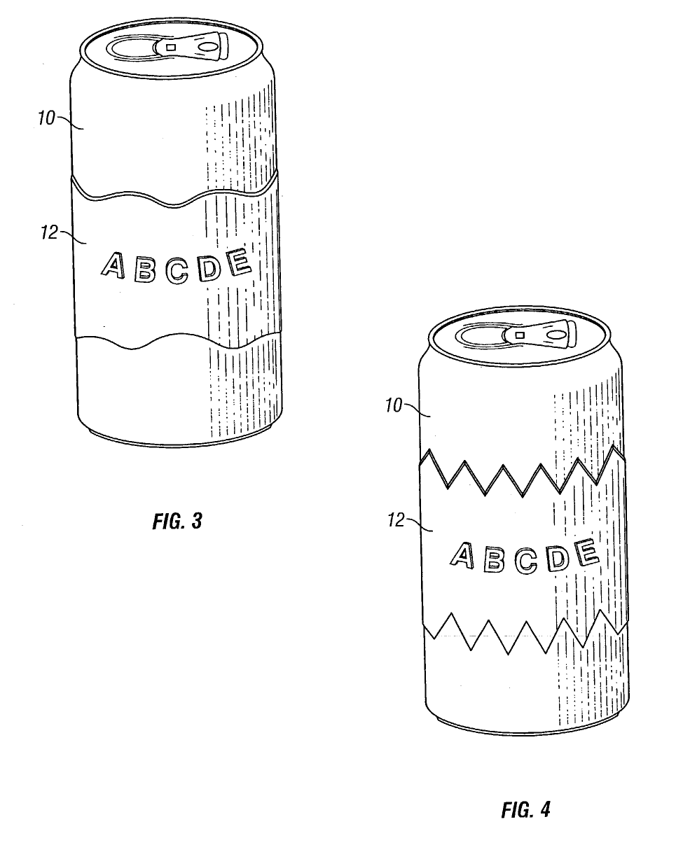

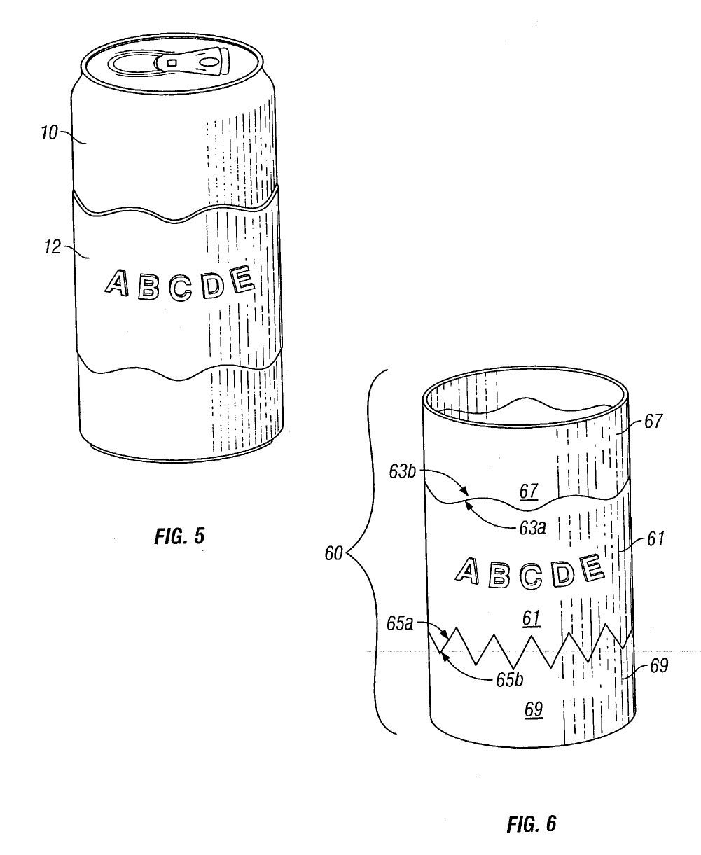

In FIGS. 3-5, alternative embodiments are seen in which the shape of elastomeric band 12 operates as an identifying indicia. Three example shapes are seen; however, other shapes will occur to those with skill in the art.

Referring again to FIG. 1, according to further embodiments, in addition to the identifying indicia, further indicia 24 are provided. In some embodiments, the further indicia comprise an award indicia. According to some such examples, the award indicia comprises a symbol recognizable by the human eye as being different from other symbols on other elastomeric bands. In further examples, award indicia 24 comprised machine-readable indicia (for example, bar codes, data matrices, etc.). In still further embodiments, the further indicia comprises advertising (for example, a logo, a slogan, etc.). In some examples, the advertising includes graphics, text, and other forms of advertising commonly found in printed matter.

In still further embodiments, the identifying indicia and/or the further indicia are applied to the inner surface of the band, thereby making the band reversible.

In some example embodiments, at the beginning of a party or other gathering, a host distributes a group of elastomeric bands to individuals attending the party. Each elastomeric band has a specific identifying indicia different from the identifying indicia of the other bands of the group. The recipients of the bands apply the bands to their beverage container at the party, thus reducing the chance of a mistake regarding who's drink is who's. This reduces waste of the beverage and containers while, at the same time, increasing hygiene. The elastomeric band is conveniently applied and removed, and it is also useful as a souvenir of the gathering, and as a wrist-band. It is also useful, in further embodiments, as a game piece for various games requiring a unique player-designation, since the specific identifying indicia of the band serves that dual purpose. There are many such games that will occur to those of skill in the art that do not require further elaboration.

In still a further embodiment, the further indicia mentioned above is used for redemption of prizes. For example, a “winning” symbol, code, logo, word, or other prize indicia is applied as the further indicia, in some examples, to one or more, but not all, of the bands in the group. In some embodiments, all of the bands in the group have some additional indicia, but not all are “winning” indicia. In alternative examples, only some of the bands in the group include further indicia, some or all of which are “winning” indicia.

In still further examples, a further indicia comprises a machine-readable image (e.g., a bar code, data matrix, etc.) that is used for security and authentication in award programs.

In some examples, a group of bands is distributed with a group of beverage containers, either in a separate package or applied to the beverage container before sale to a consumer. Redemption of a prize or other through return of the band to an authorized entity. Having a specific identifying indicia of each beverage container in the group sold allows for the vendor of the group to add value, and application of the band to the container before sale reduces the efforts needed by the purchaser.

In an even further embodiment, the bands include “sayings” or other expressions. In some examples, the expressions themselves serve as the specific identifying indicia within a given group; in other examples, the expressions are not unique to any particular band in a group and a specific identifying indicia are included with the expressions.

In still further examples, a group of bands including specific identifying indicia for each band also include related bands. For example, in a group of six bands, each being consecutively numbered as specific identifying indicia, there are two bands of a first color, two bands of a second color, and two bands of a third color. Related bands from such a group allow for various “ice-breaking” games to be played, according to one example of the invention, while still allowing specific identification of each beverage container. Further relating of bands, with other numbers of bands being related, is provided for in other example embodiments. In one specific example, a group of bands is sold with ½ of the bands being blue and ½ of the bands being pink. One of the pink bands has the word “after” and the related blue band includes the word “hours.” The holder's of these two bands then find each other in the ice breaking game. Other related pair-words are on other related blue and pink bands in the group of bands.

According to still further example embodiments, relating is performed by a variety of indicia (for example, shape, color, slogans, sayings, color combinations, machine-readable fields, etc.). In at least one such example, the elastomeric bands have a shaped edge (e.g. FIGS. 3-5). In a group of bands, a related pair of bands includes mating shapes of the edges. As seen in the example of FIG. 6, a related trio of bands is provided, in one example, in which a first band 61 in the trio 60 includes two mating edges 63a and 65a and the other two bands 67 and 69 in the trio 60 each mate with at least one side of the first band through mating edges 63b and 65b of bands 67 and 69, respectively.

The above embodiments have been given by way of example only. Further examples will occur to those of skill in the art without departing from the spirit of the invention.

What is claimed is:

1. A system of identifying a specific beverage container from a group of beverage containers to a specific individual from a group of individuals, the system comprising:
elastomeric means for engaging an outer surface of the container, and
means for displaying, opposite the means for engaging of the elastic compressive force, a specific identifying indicia.

2. A system as in claim 1 wherein said elastomeric means for engaging comprises a means for applying an elastic compressive force to the outer surface of the container.

3. A system as in claim 1 wherein said means for applying comprises an inner surface of an elastomeric band.

4. A system as in claim 1 wherein said means for engaging comprises further means for applying a frictional engagement of the elastic compressive force to the outer surface of the container.

5. A system as in claim 4 wherein said means for applying a frictional engagement comprises an inner surface of an elastomeric band.

6. A system as in claim 1 wherein said means for displaying comprises an elastomeric band.

7. A system as in claim 6 wherein said means for displaying comprises means for displaying an alpha-numeric indicia.

8. A system as in claim 6 wherein said means for displaying comprises means for displaying a color indicia.

9. A system as in claim 8 wherein said means for displaying comprises means for displaying a multi-color indicia.

10. A system as in claim 6 wherein said means for displaying comprises means for displaying an alpha-numeric indicia.

11. A system as in claim 1 wherein said means for displaying comprises an outer surface of an elastomeric band.

12. A system as in claim 1 further comprising means for displaying a further indicia.

13. A system as in claim 12 wherein the further indicia comprises an award indicia.

14. A system as in claim 12 wherein the further indicia comprises advertising.

15. A system as in claim 14 wherein the advertising comprises a logo.

16. A system as in claim 14 wherein the advertising comprises a slogan.

17. A system as in claim 1 further comprising:
means for relating the specific beverage container with at least one other beverage container from the group of beverage containers.

18. A system as in claim 17 wherein the means for relating comprises:
means for displaying a first relating indicia on the beverage container, and
means for displaying a second relating indicia on the at least one other beverage container.

19. A system as in claim 18 wherein the means for displaying a first relating indicia comprises a first elastomeric band and the means for displaying a second relating indicia on the at least one other beverage container comprises a second elastomeric band.

20. A system as in claim 19 wherein the first relating indicia comprises a first shape of the first elastomeric band and the second relating indicia comprises a second shape of the second elastomeric band.

21. A system as in claim 20 wherein the first shape mates with the second shape.

22. A system as in claim 18 wherein the first relating indicia comprises a color of the first elastomeric band and the second relating indicia comprises a color of the second elastomeric band relating the color of the first elastomeric band.

23. A system as in claim 21 wherein the color of the first elastomeric band and the color of the second elastomeric band consist essentially of the same color.

24. A system as in claim 21 wherein the color of the first elastomeric band and the color of the second elastomeric band consist essentially of complementary colors.

25. A system as in claim 18 wherein the first relating indicia comprises a number on the first elastomeric band and the second relating indicia comprises the number.

26. A system as in claim 18 wherein the first relating indicia comprises a letter on the first elastomeric band and the second relating indicia comprises the letter.

27. A method for distinctly identifying multiple beverage containers, the method comprising:
distributing a group of elastomeric bands, wherein each band in the group includes an identifying indicia different from other bands in the group of bands; and
applying the group of bands to a group of beverage containers.

28. A method as in claim 27 wherein the identifying indicia comprises and alpha-numeric indicia.

29. A method as in claim 27 wherein the identifying indicia comprises a color indicia.

30. A method as in claim 29 wherein identifying indicia comprises an alpha-numeric indicia.

31. A method as in claim 29 wherein the color indicia comprises a multi-color indicia.

32. A method as in claim 31 wherein identifying indicia comprises an alpha-numeric indicia.

33. A method as in claim 27 wherein each band further includes a further indicia.

34. A method as in claim 33 wherein the further indicia comprises an award indicia.

35. A method as in claim 33 wherein the further indicia comprises advertising.

36. A method as in claim 35 wherein the advertising comprises a logo.

37. A method as in claim 35 wherein the advertising comprises a slogan.

38. A device for identification of a beverage container, the device comprising:
an elastomeric band having an inner surface and an outer surface; and
an identifier of the elastomeric band viewable from the outer surface, wherein the identifier of the elastomeric band is integral with the outer surface.

39. A device as in claim 38 wherein the identifier comprises an alpha-numeric character on the outer surface.

40. A device as in claim 38 wherein the identifier is printed on the outer surface.

41. A device as in claim 38 wherein the identifier is formed in the outer surface.

42. A device as in claim 38 wherein the identifier comprises a symbol having a color different from the color of a background of the outer surface.

43. A device as in claim 38 wherein the identifier comprises an identifying portion of the outer surface having a level different from a background of the outer surface.

44. A device as in claim 43 wherein the identifier comprises a raised portion.

45. A device as in claim 43 wherein the identifier comprises a recessed portion.

46. A device as in claim 38 wherein the identifier comprises a further indicia.

47. A device as in claim 46 wherein the identifier comprises an award indicia.

48. A device as in claim 46 wherein the identifier comprises advertising.

49. A device as in claim 48 wherein the advertising comprises a logo.

50. A device as in claim 48 wherein the advertising comprises a slogan.

51. A system of identification of a plurality of beverage containers, the system comprising:
a group of elastomeric bands wherein each band comprises an inner surface and an outer surface; and
a unique identifier of the each elastomeric band viewable from the outer surface, wherein the unique identifier is integral with the outer surface.

52. A system as in claim 51 wherein the identifier comprises an alpha-numeric character on the outer surface.

53. A system as in claim 51 wherein the identifier is printed on the outer surface.

54. A system as in claim 51 wherein the identifier is formed in the outer surface.

55. A system as in claim 51 wherein the identifier comprises a symbol having a color different from the color of a background of the outer surface.

56. A system as in claim 51 wherein the identifier comprises an identifying portion of the outer surface having a level different from a background of the outer surface.

57. A system as in claim 56 wherein the identifier comprises a raised portion.

58. A system as in claim 56 wherein the identifier comprises a recessed portion.

59. A system as in claim 51 wherein the identifier comprises a further indicia.

60. A system as in claim 59 wherein the identifier comprises an award indicia.

61. A system as in claim 59 wherein the further indicia comprises advertising.

62. A system as in claim 61 wherein the advertising comprises a logo.

63. A system as in claim 61 wherein the advertising comprises a slogan.

64. A beverage container, comprising:
an outer surface of a container, and
device for identification of a beverage container, the device comprising:
an elastomeric band having an inner surface and an outer surface; and
an identifier of the elastomeric band viewable from the outer surface, wherein the identifier of the elastomeric band is integral with the outer surface.

65. A device as in claim 64 wherein the identifier comprises an alpha-numeric character on the outer surface.

66. A device as in claim 64 wherein the identifier is printed on the outer surface.

67. A device as in claim 64 wherein the identifier is formed in the outer surface.

68. A device as in claim 64 wherein the identifier comprises a symbol having a color different from the color of a background of the outer surface.

69. A device as in claim 64 wherein the identifier comprises an identifying portion of the outer surface having a level different from a background of the outer surface.

70. A device as in claim 69 wherein the identifier comprises a raised portion.

71. A device as in claim 69 wherein the identifier comprises a recessed portion.

72. A device as in claim 64 wherein the identifier comprises a further indicia.

73. A device as in claim 72 wherein the identifier comprises an award indicia.

74. A device as in claim 72 wherein the identifier comprises advertising.

75. A device as in claim 74 wherein the advertising comprises a logo.

76. A device as in claim 74 wherein the advertising comprises a slogan.
